(19) United States
(12) Patent Application Publication
(10) Pub. No.: US 2017/0372214 A1
(43) Pub. Date: Dec. 28, 2017

(54) UPDATES TO A PREDICTION MODEL USING STATISTICAL ANALYSIS GROUPS

(71) Applicant: ENTIT SOFTWARE LLC, Sunnyvale, CA (US)

(72) Inventors: Hao Peng, West Lafayette, IN (US); Manish Marwah, Palo Alto, CA (US); Krishnamurthy Viswanathan, Palo Alto, CA (US); Indrajit Roy, Palo Alto, CA (US)

(21) Appl. No.: 15/545,008

(22) PCT Filed: Jan. 30, 2015
(86) PCT No.: PCT/US2015/013897

§ 371 Date: Jul. 20, 2017

(51) Int. Cl. G06N 7/00; G06K 9/62; G06N 99/00; G06F 17/18; G06N 5/04

(52) U.S. Cl. CPC G06N 7/005; G06N 99/005; G06F 17/18; G06K 9/6282; G06N 5/047

(57) ABSTRACT

Method, systems, and computer-readable storage devices for updating a prediction model are described. In one aspect, a statistical analysis group assignment may be received. The statistical analysis group assignment may group partition-level worker node and a first set of partition-level worker nodes as a statistical analysis group. A statistical analysis phase may then be executed where a group-level decision tree is generated from statistical data and other statistical data received from the first set of partition-level worker nodes. A decision tree analysis phase may then be executed, where a step decision tree may be generated based on a selection from the group-level tree and other group-level trees received from other statistical analysis groups. The prediction model may be caused to be updated using the step decision tree.

### BACKGROUND

Some computer systems may execute applications for classifying, clustering, or otherwise outputting a real-valued output based on an input data. For example, in a computer system that classifies input data, the computer system may identify to which of a set of categories or sub-populations the input data belongs, on the basis of a training set of data containing observations (or instances) whose category membership are known. To illustrate, in some cases, the computer system can assign or otherwise label a given email as “spam” or “non-spam.” In other cases, the computer system may assign a diagnosis to a given patient as described by observed characteristics of the patient (gender, blood pressure, presence or absence of certain symptoms, etc.).

### BRIEF DESCRIPTION OF DRAWINGS

Examples are described in detail in the following description with reference to implementations shown in the following figures:

FIG. 1 is a block diagram illustrating a hybrid learning system, according to an example;

FIGS. 2A-C are block diagrams illustrating various computer systems, according to examples; and

FIG. 3 is a flowchart showing a method for updating a prediction model, according to an example.

### DETAILED DESCRIPTION

This disclosure discusses, among other things, methods, systems, and computer-readable storage devices that may, in some cases, update a prediction model using statistical analysis groups. In some cases, this approach to update a prediction model may be used in a pattern recognition systems, such as systems using a classification application or regression application. As used herein, a “prediction model” may be data or logic usable to classify, duster, or otherwise output a real-valued output based on an input data. A prediction model can be constructed based on training data. In some cases, the prediction model can be represented as decision trees, a collection of decision trees with weighted outputs, or the like.

Some pattern recognition systems may build a prediction model using a training data set to classify or assign values to input data. One approach for building a prediction model is to use a gradient boosting machine (otherwise referred to as GBM) technique. In a system utilizing GBM, the system may construct a collection of decision trees in a sequential fashion. At any point during the construction, a feature from the training data set is selected as the root node of a tree based on previously constructed trees as well as the relationship between the different features and the labels (as may be the case in a classification system) or response variables (as may be the case in a regression system). Once a feature is selected, the training dataset is partitioned based on the feature value. This partitioning may be referred to herein as “splitting a node subsequently.” The GBM technique can then proceed by repeating this process recursively on the two resultant datasets. Once a tree reaches a certain depth, the tree is added to the model and weights are updated for the construction of new trees.

It is to be noted, however, that the sequential execution of the GBM technique makes it difficult to parallelize this technique and, accordingly, performance can suffer depending on input data size.

Some examples discussed in the foregoing may provide a distributed approach for updating or otherwise building prediction models. In a distributed approach, the training data set (e.g., the data used to training the prediction model) is partitioned or otherwise distributed across a number nodes that perform local computations. These nodes may be referred to herein as partition-level worker nodes. In some cases, partition-level worker nodes may be assigned to groups referred to herein as statistical analysis groups. A partition-level worker node in a statistical analysis group may communicate with other partition-level worker nodes that are members of the same statistical analysis group.

Further, some implementations may execute according to different stages. The first stage may be referred to as a statistical analysis phase. In the statistical analysis phase, statistical data are calculated on data stored on the data partitions. Calculating histograms, averages, or any other mathematical calculation are examples of statistical data that may be generated during the statistical analysis phase. Statistical data may also be calculated on data at the group-level. Group-level statistical data may be an aggregation of statistical data calculated by partition-level worker nodes of a given statistical analysis group. Examples of group-level statistical data may include histograms that aggregate the histograms of a group, averages, or, in some cases, decision trees generated from the statistical data of a group.

Another phase may be a data tree analysis phase. A data tree analysis phase may be a phase in which various group-level decision trees are analysed. A “group level decision tree” may be a data structure (e.g., a decision tree) that labels, categorizes, or generates a value for an input data. The group-level decision tree may be formed from the statistical data generated by a group of partition-level worker nodes. By way of example and not limitation, one type of analysis that may be performed in the data tree analysis phase is to select a group-level decision tree with the minimum loss among the group-level decision trees generated by the different groups of partition-level worker nodes. The group-level decision tree may be referred to herein as a “step decision tree.” Such may be the case because the step decision tree is the decision tree used in a boosting step to update a prediction model. It should be appreciated that a step decision tree can include data or logic other than trees. For example, rather than selecting a tree among the group-level decision trees, a step decision tree may be a collection of the various group-level decision trees. In this case, the output of the step decision tree (e.g., a label) may be based on a weighted average of the outputs generated by the collection of group-level decision trees.

Different aspects are now explained by way of example and not limitation. In one aspect, a first set of partition-level worker nodes may be assigned to a first statistical analysis group and a second set of partition-level worker nodes may be assigned to a second statistical analysis group. A statistical analysis phase may then be executed. A statistical analysis phase may include obtaining a first group-level decision tree from first statistical analysis data received from the first statistical analysis group and receiving a second group-level decision tree from second statistical analysis data received from the second statistical analysis group. A decision tree analysis phase may then be executed. A decision tree analysis phase may include using the first group-level decision tree and the second group-level decision tree to generate a step decision tree. A prediction model may then be updated based on the step decision tree.

In another aspect, an example may receive a statistical analysis group assignment that groups a set of data partitions to a statistical analysis group. Then, statistical data from data partitions worker nodes executing local to the set of data partitions may be received. A group-level decision tree may then be generated from the statistical data received from the data partition worker nodes. The group-level decision tree may be selected from other group-level decision trees generated from other statistical analysis groups. A prediction model be caused to be updated based on the group-level decision.

In another aspect, an example may receive, by a partition-level worker node for a data partition, a statistical analysis group assignment that groups the partition-level worker node and a first set of partition-level worker nodes as a statistical analysis group. A processor may then execute a statistical analysis phase on the partition-level worker node. The statistical analysis phase include generating a group-level decision tree from statistical data derived from the data partition and the other statistical data received from the first set of partition-level worker nodes. Further, the processor may execute a decision tree analysis phase on the partition-level worker node. The statistical analysis phase, the processor may generate a step decision tree based on a selection made from the group-level tree and other group-level trees received from other statistical analysis groups. The processor may then cause a prediction model to be updated using the step decision tree.

These and other examples are now described in greater detail.

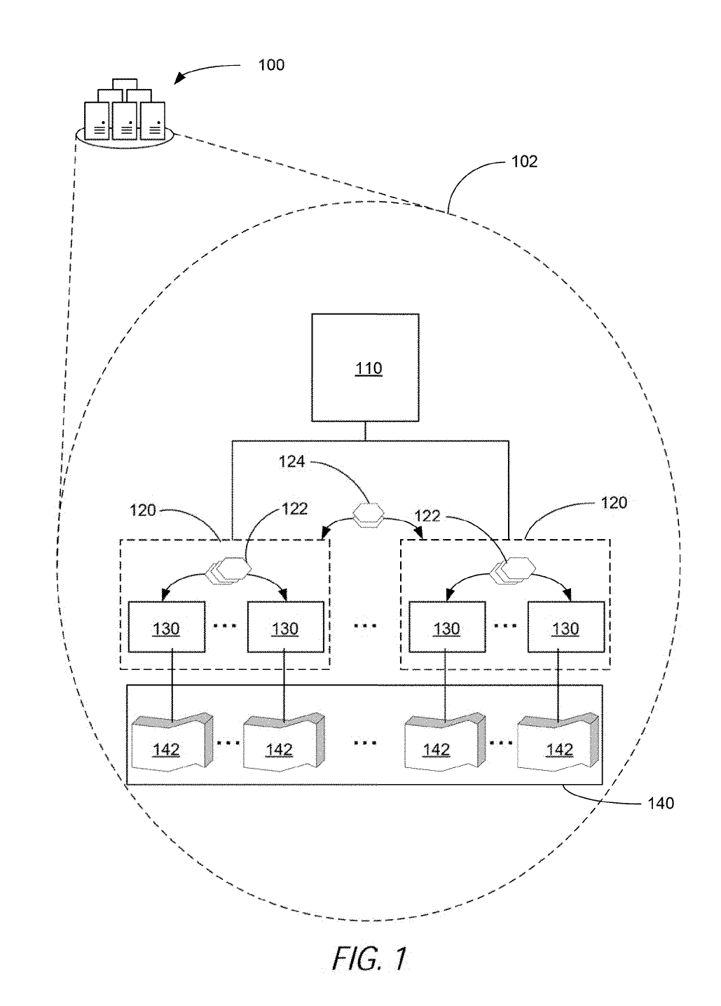

FIG. 1 is a block diagram illustrating a hybrid learning system 100, according to an example. The hybrid learning system 100 may be a sub-system of a prediction system that is configured to generate a prediction model based on a hybrid approach that combines a statistical analysis and decision tree analysis in a distributed system. The hybrid learning system 100 may include, as shown in the close-up view 102 of the hybrid learning system 100, a hybrid analysis coordinator 110, statistical analysis groups 120, partition-level worker nodes 130, and a training data set 140.

In describing FIG. 1 from the bottom-up, the training data set 140 is a data set used to generate a prediction model. The training data set 140 may be divided into multiple data partitions 142. Each of the data partitions may include a subset of the training data set. A data partition may in some cases include multiple samples. A sample can be an observation record which, in some cases, may be represented as a vector of data values for different features. Each sample may also be assigned a label. By way of example and not limitation, an observation record may include a first feature that represents a person's height, a second feature that represents a person's weight, a third feature that represents a person's age, and so forth. Further, the sample may also include a label indicating that the person was positive for a condition. The data partitions 142 may include other such samples for other patients, with, in turn, patient specific features.

Each data partition may be stored in a computer system local to one of the partition-level worker nodes 130. A partition-level worker node may be computer-implemented module that is configured to perform statistical analysis on a respective data partition. The result of the statistical analysis is statistical data. Generating a histogram on a feature or features of the samples in the data partitions is an example of a type of statistical analysis a partition-level worker node may perform. The partition-level worker nodes may be configured further to send statistical analysis data 122 within a statistical analysis group.

FIG. 1 shows that the partition-level worker nodes 130 may further be assigned or otherwise organized in statistical analysis groups 120. Partition-level worker nodes assigned to a statistical analysis group may exchange statistical analysis data among other partition-level worker nodes assigned to that statistical analysis group. Further, the statistical analysis group may aggregate the statistical analysis data generated by the constituent partition-level worker nodes. Statistical analysis data that is aggregated by a statistical analysis group may be referred to herein as group statistical analysis data. Group statistical analysis data may take many forms. For example, where each partition-level worker generates a histogram of a feature at a corresponding data partition, the group statistical analysis data may take the form of a histogram that aggregates the data found in the various histograms. Alternatively or additionally, also where each partition-level worker generates a histogram of a feature at a corresponding data partition, the group statistical analysis data may take the form of a decision tree generated from a histogram that aggregates the data found in the various histograms.

As is described in greater detail in the foregoing, the group statistical analysis data are generated during a statistical analysis phase executed by the hybrid learning system 102. After the statistical analysis phase, the hybrid learning system 102 may perform a decision tree analysis phase. In the decision tree analysis phase, the statistical analysis groups 130 may exchange group-level decision trees 124 generated from the group statistical analysis data. The exchange of the group-level decision trees may be used to calculate predictions at the leaf nodes and to compute the losses on the training data set. Based on the losses, a group-level decision tree may be selected from the group-level decision trees, and the selected group-level decision tree may be used to update the prediction model.

In some cases, to generate a prediction model, multiple iterations of the statistical analysis phase and decision tree analysis phase are executed. Further, before executing this iterations, different partition-level worker nodes may be assigned to the statistical analysis groupings.

The hybrid analysis coordinator 110 may be a computer-implemented module executed by a computer system and configured to coordinate, collect, and otherwise manage the activities of the statistical analysis groups 120. For example, in some cases, the hybrid analysis coordinator 110 may assign partition-level worker nodes to statistical analysis groups. Still further, the hybrid analysis coordinator may also select a group-level decision tree to use in updating the prediction model.

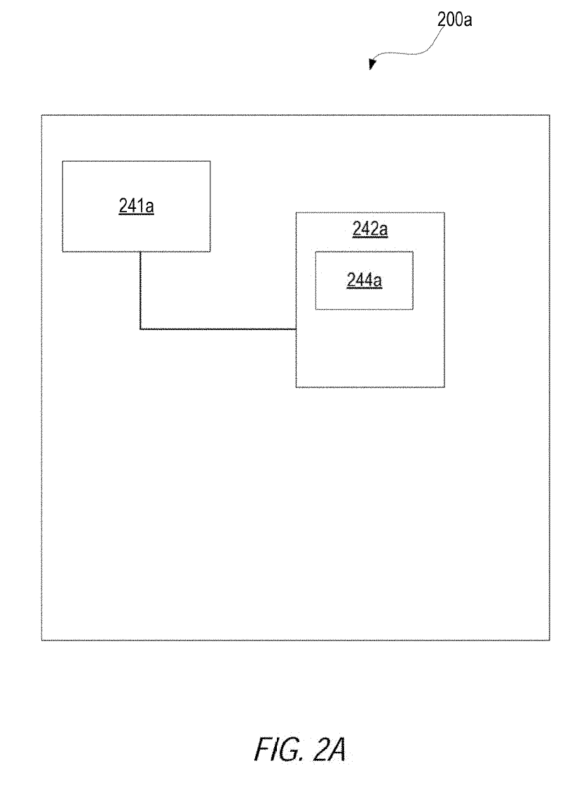

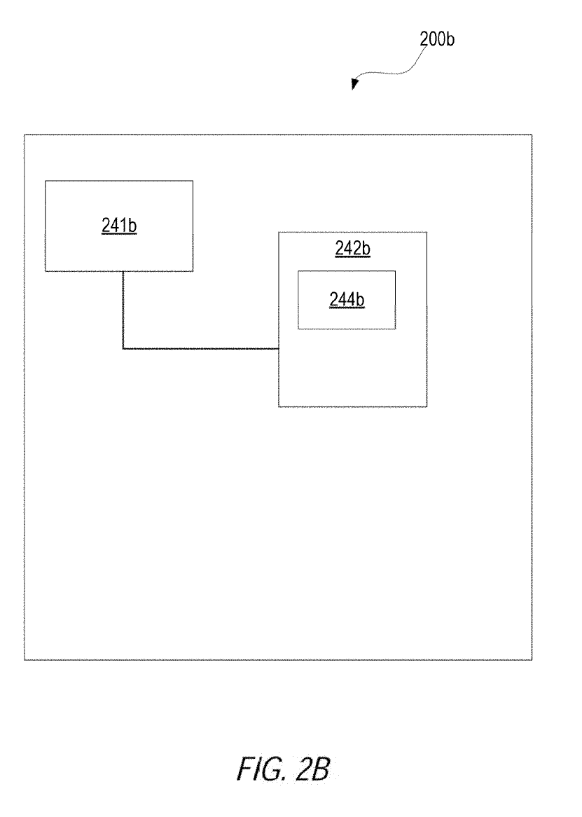

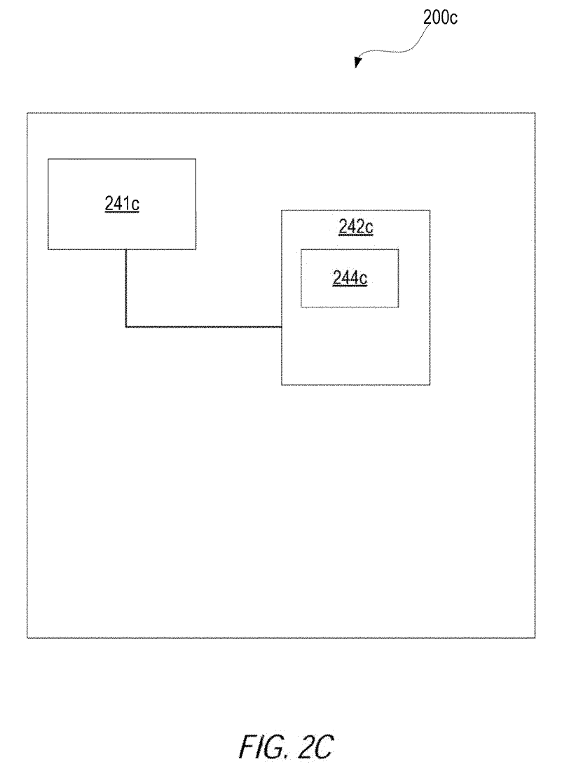

It is to be appreciated that the hybrid analysis coordinator 110, the statistical analysis groups 120, the partition-level worker nodes 130, and the training data set 140 may be executed on the same or different computer systems, depending on implementation. For example, FIG. 2A is a block diagram illustrating a computer system 200a configured to execute a hybrid analysis coordinator as a centralized point of control, in accordance with an example. That is, in some cases, the hybrid analysis coordinator may be a computer system or computational node that executes separately from the partition-level worker nodes.

The computer system 200a may include a processor 241a and a computer-readable storage device 242a. The processor 241a may be a device suitable to read and execute processor executable instructions, such as a central processing unit (CPU), or an integrated circuit configured to perform a configured function.

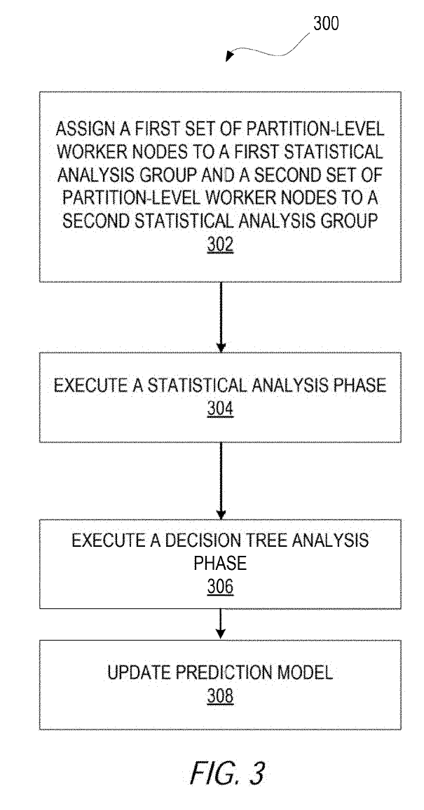

The processor 241a may be coupled to the computer-readable storage device 242a. The computer-readable storage device 242a may contain thereon a set of instructions, which when executed by the processor 241a, cause the processor 241a to execute the techniques described herein. For example, the computer-readable storage device 242a may include centralized hybrid analysis coordinator instructions 244a. With regards to the centralized hybrid analysis coordinator instructions 244a, execution of the instructions 144a, whole or in part, may cause the processor 241a to update a prediction model may coordinating activities within a statistical analysis group, which is described in greater detail below with reference, for example, to FIG. 3.

In other examples, some of the functionality of updating a prediction model may be distributed among the partition-level worker nodes executing in the hybrid learning system 100. For example, FIG. 2B is a block diagram illustrating a computer system 200b configured to execute some of the functionality discussed herein, according to an example. In some cases, the computer system 200b may be a computer system or computational node that executes separately from the partition-level worker nodes and/or a hybrid analysis coordinator. For example, the computer system 200b may be operating as a master node for a statistical analysis group and each statistical analysis group may have a corresponding computer system 200b, in accordance with an example.

The computer system 200b may include a processor 241b and a computer-readable storage device 242b. The processor 241b may be a device suitable to read and execute processor executable instructions, such as a central processing unit (CPU), or an integrated circuit configured to perform a configured function.

The processor 241b may be coupled to the computer-readable storage device 242b. The computer-readable storage device 242b may contain thereon a set of instructions, which when executed by the processor 241b, cause the processor 241b to execute the techniques described herein. For example, the computer-readable storage device 242b may include distributed statistical analysis group instructions 244b that cause a processor to receive a statistical analysis group assignment that groups a set of data partitions to a statistical analysis group. Then, statistical data from data partitions worker nodes executing local to the set of data partitions may be received. A group-level decision tree may then be generated from the statistical data received from the data partition worker nodes. The group-level decision tree may be selected from other group-level decision trees generated from other statistical analysis groups. A prediction model be caused to be updated based on the group-level decision.

In other examples, some of the functionality of updating a prediction model may be distributed among the partition-level worker nodes executing in the hybrid learning system 100. For example, FIG. 2C is a block diagram illustrating a computer system 200c configured to execute some of the functionality discussed herein, according to an example. In some cases, the computer system 200c may be a computer system or computational node that executes within the partition-level worker nodes.

The computer system 200c may include a processor 241c and a computer-readable storage device 242c. The processor 241c may be a device suitable to read and execute processor executable instructions, such as a central processing unit (CPU), or an integrated circuit configured to perform a configured function.

The processor 241c may be coupled to the computer-readable storage device 242c. The computer-readable storage device 242c may contain thereon a set of instructions, which when executed by the processor 241c, cause the processor 241c to execute the techniques described herein. For example, the computer-readable storage device 242c may include partition-level worker nodes instructions 244b that cause a processor to receive, by a partition-level worker node for a data partition, a statistical analysis group assignment that groups the partition-level worker node and a first set of partition-level worker nodes as a statistical analysis group. The processor may then execute a statistical analysis phase on the partition-level worker node. The statistical analysis phase include generating a group-level decision tree from statistical data derived from the data partition and the other statistical data received from the first set of partition-level worker nodes. Further, the processor may execute a decision tree analysis phase on the partition-level worker node. The statistical analysis phase, the processor may generate a step decision tree based on a selection made from the group-level tree and other group-level trees received from other statistical analysis groups. The processor may then cause a prediction model to be updated using the step decision tree.

Operations of computer systems executing a hybrid learning system are now discussed. FIG. 3 is a flowchart showing a method 300 for updating a prediction model, according to an example. The method 300 may be performed by the modules, components, systems, and instructions shown in FIGS. 1 and 2A-C, and, accordingly, is described herein merely by way of reference thereto. It will be appreciated that the method 300 may, however, be performed on any suitable hardware.

As FIG. 3 shows, the method 300 may include the following operations: (a) operation 302, which assigns partition worker nodes to statistical analysis groups; (b) operation 304, which executes a statistical analysis phase; (c) operation 306, which executes a decision tree analysis phase; and (d) operation 308, which updates a prediction model. Collectively, the operations 302, 304, 306, 308 may be part of a boosting iteration for a GBM that generates a prediction model from training data.

Operations 302, 304, 306, and 308 are now described in greater detail.

At operation 302, a hybrid analysis coordinator assigns a first set of partition-level worker nodes to a first statistical analysis group and a second set of partition-level worker nodes to a second statistical analysis group. Because partition-level worker nodes operate on data partitions, this assignment also groups data partitions to statistical analysis groups. For example, suppose the training data set includes or is otherwise divided into P partitions, the hybrid analysis coordinator may divide the partitions into groups of size K, which can be, in some cases, an integer between 1 and P. The hybrid analysis coordinator may choose the groups to be disjoint, such that there can be (P/K) groups. It is to be noted that in some cases the last statistical analysis group can have between 1 and K partitions.

In one implementation, the hybrid analysis coordinator assigns the partition-level worker nodes randomly using the following strategy. To begin, the hybrid analysis coordinator can create indexes from 1 to N, and then perform a random shuffle of the indexes. The hybrid analysis coordinator can select the partitions corresponding to the first K indices as the first group, and similarly for up to

$$⌈ \frac{P}{K} ⌉$$

groups. In some cases, the number of statistical analysis groups may be controlled by a user-supplied parameter. For example, in some cases, the hybrid learning system can receiving a user supplied grouping parameter, such as a group size (e.g., K) or a number of groups (e.g., N). In such cases, the assignment of the first set of partition-level worker nodes to the first statistical analysis group and the second set of partition-level worker nodes to the second statistical analysis group operates according to the user supplied grouping parameter.

Grouping can result in information from different partitions being shared. In some cases, random grouping can help increase the accuracy of the hybrid based prediction model, because the decision trees may be built on a group of partitions but not just one partition.

Other examples can assign data partitions to statistical analysis groups in different ways. In one case, the hybrid analysis coordinator can choose the next permutation in order instead of a random shuffling, which can save in processing time incurred by shuffling the partitions but can reduce randomness. In another case, the hybrid analysis coordinator can create groups in each iteration such that no pair of partitions in the new group was in the same group in the previous iteration(s). Such a grouping can improve the spread of information, but also may increase processing time by creating these restricted groupings. In yet another case, on a shared memory infrastructure, the groups do not need to be disjoint, and a partition can appear in multiple groups. As a partition can appear in multiple groups, the hybrid analysis coordinator can use sampling with replacement to select the partitions for each group.

At operation 304, the hybrid analysis coordinator may execute a statistical analysis phase. The statistical analysis phase may include the hybrid analysis coordinator obtaining a first group-level decision tree from first statistical analysis data received from the first statistical analysis group and a second group-level decision tree from second statistical analysis data received from the second statistical analysis group. To illustrate, after assigning the partition-level worker nodes to the statistical analysis groups, the hybrid analysis coordinator may cause the partition-level worker nodes of the statistical analysis groups to generate statistical data from the corresponding data partitions. In some cases, the partition-level worker nodes may use a histogram-based approach in generating statistical data. Using a histogram-based approach, the partition-level worker nodes can build histograms for each feature and each terminal node on their respective data partition. Building these histograms can include two steps. The first step can be adding a new bin, which may involve adding a new bin in a histogram. A bin is a tuple (e.g., a data structure) which consists of the center of the data points, the sum of response values, and the number of data points. The second step is merging bins, which is invoked if the number of bins in a histogram exceeds a limit. Then two bins with the minimum distance of their centers can be merged to one. To build a histogram for a feature, a partition-level worker node sorts the data by that feature, which can be done once. Then the partition-level worker node can treat each data point of that feature as a single bin and adds the feature to a histogram sequentially, merging if necessary. Using this approach, an approximate histogram can be built through just one pass of the data.

Once the partition-level worker nodes build the histograms for the terminals and the features on the data partitions, the statistical analysis groups collect the histograms at the group level. For each statistical analysis group, a statistical analysis group may combine the histograms from all partitions in this assignment group for every feature. Combining histograms in this case may involve concatenating the bins from the different histograms, sorted by the centers of the bins. Sorting can occur before or during the merging process. Then the median point between the centers of consecutive two bins may be used as a candidate split point.

Because statistical data is communicated between members of a statistical analysis group, this method distributes the work of combining histograms to multiple

$$( ⌈ \frac{P}{K} ⌉ )$$

nodes. This reduces the communication cost and computation time compared to a purely histogram-based approach (e.g., communicating histograms across each partition).

Other implementations can use a fixed-width histogram approach. In fixed-width histogram approach, low and high values of the data points are exchanged first to decide the bin width. Then the sum of response values and the number of samples are computed for each bin. Further, it is not the case that a split point has to be the median between two consecutive bins. Some cases, a split point can be approximated based on a density estimation.

A statistical analysis group can combine histograms on any number of nodes executing on a hybrid learning system. In one case, histograms from a statistical analysis group are combined at a single node or process. However, in different cases, there may be multiple nodes, for example, equal to the number of partitions. In such a configuration, the histograms may be divided by features and terminal nodes, so that each process can be utilized. This can, in some situations, speed up processing time even further.

Operation 306 is now described in greater detail. At operation 306, the hybrid analysis coordinator may execute a decision tree analysis phase. The decision tree analysis phase may include using the first group-level decision tree and the second group-level decision tree to generate a step decision tree. In generating the step decision tree, the hybrid analysis coordinator may then select from the first group-level decision tree and the second group-level decision tree based on a comparison of cost/error level. This selection may involve two steps: (a) fitting best predictions, and (b) computing losses. In the first step, group-level decision trees are received by the hybrid analysis coordinator. Then, the hybrid analysis coordinator may compute statistics to fit prediction values for each feature and each terminal for each of the group-level decision trees. For example, if a sum of squared errors loss is used, the statistics may be the sum of response values and number of samples. Then these statistics are combined and predictions are updated for each terminal node.

In the second step, the hybrid analysis coordinator exchanges updated trees again to compute a local loss on each partition. Then, the local losses for each decision tree are summed and the decision tree with the smallest loss is added to the GBM model.

It is to be appreciated that in the decision tree analysis phase, information (e.g., data trees) across different groups are exchanged rather than across partitions, which improves the accuracy of decision trees.

In other examples, alternative ways to select the decision tree can be deployed. For example, the sample data-distributed LambdaMART approach can be used. In this approach, the second step of computing the best tree is omitted. Instead, a decision tree is selected randomly from all candidate trees. This approach may execute faster uses less time but is less accurate. Another method is to use a weighted combination of all trees. This way we add multiple trees to the GBM model in one iteration; there are several ways to assign weights of the trees, e.g., based on their performance on a test data set.

At operation 308, the hybrid analysis coordinator may update a prediction model based on the step decision tree. As described above, a prediction model may be data or logic that identifies to which of a set of categories, sub-populations, or prediction-value an input data belongs.

What is claimed is:

1. A method comprising:
assigning a first set of partition-level worker nodes to a first statistical analysis group and a second set of partition-level worker nodes to a second statistical analysis group;
executing a statistical analysis phase, the statistical analysis phase includes obtaining a first group-level decision tree from first statistical analysis data received from the first statistical analysis group and a second group-level decision tree from second statistical analysis data received from the second statistical analysis group;
executing a decision tree analysis phase, the decision tree analysis phase includes using the first group-level decision tree and the second group-level decision tree to generate a step decision tree; and
updating a prediction model based on the step decision tree.

2. The method of claim 1, wherein the first set of partition-level worker nodes are each assigned a data partition from a training data set.

3. The method of claim 1, further comprising:
receiving a user supplied grouping parameter, wherein the assignment of the first set of partition-level worker nodes to the statistical analysis group and the second set of partition-level worker nodes to the second statistical analysis group operates according to the user supplied grouping parameter.

4. The method of claim 1, wherein the statistical analysis includes generating, by one of the statistical analysis worker nodes of the first set of statistical analysis worker nodes, a histogram of a feature found in samples stored in a corresponding data partition.

5. The method of claim 4, further comprising:
communicating the histogram with other statistical analysis worker nodes of the first set of statistical analysis worker nodes; and
receiving other histograms from the other statistical analysis worker nodes of the first set of statistical analysis worker nodes.

6. The method of claim 1, wherein generating the step decision tree comprises selecting between the first group-level decision tree and the second group-level decision tree based on respective error levels associated with the first group-level decision tree and the second group-level decision tree.

7. The method of claim 1, wherein generating the step decision tree comprises averaging the first group-level decision tree and the second group-level decision.

8. The method of claim 1, wherein assigning the first set of partition-level worker nodes to the statistical analysis group and the second set of partition-level worker nodes to the second statistical analysis group comprises randomly selecting a first set of data partitions for the first data partition group and a second set of data partitions for the second data partition group.

9. The method of claim 1, further comprising, after updating the prediction model:
assigning a third set of partition-level worker nodes to the first statistical analysis group and a fourth set of partition-level worker nodes to the second statistical analysis group, wherein the first set of partition-level worker nodes and the third set of partition-level worker nodes map to different data partitions, the second set of partition-level worker nodes and the fourth set of partition-level worker nodes map to different data partitions;
executing another iteration of the statistical analysis phase, the another iteration of the statistical analysis phase includes obtaining a third group-level decision tree from third statistical analysis data received from the third statistical analysis group and a fourth group-level decision tree from fourth statistical analysis data received from the fourth statistical analysis group;
executing another iteration of the decision tree analysis phase, the another iteration of the decision tree analysis phase includes using the third group-level decision tree and the fourth group-level decision tree to generate an another step decision tree; and
updating the prediction model based on the another step decision tree.

10. A device comprising:
a processor, and
a machine-readable storage device comprising instructions that, when executed, cause the processor to:
receive a statistical analysis group assignment that groups a set of data partitions to a statistical analysis group;
receive statistical data from data partitions worker nodes executing local to the set of data partitions;
generate a group-level decision tree from the statistical data received from the data partition worker nodes;
select the group-level decision tree from other group-level decision trees generated from other statistical analysis groups; and
cause a prediction model to be updated based on the group-level decision.

11. The device of claim 10, wherein the instructions further cause, when executed, the processor to:
select the group-level decision tree based on losses associated with the group-level decision tree and the other group-level decision trees.

12. A machine-readable storage device comprising instructions that, when executed, cause a processor to:
receive, by a partition-level worker node for a data partition, a statistical analysis group assignment that groups the partition-level worker node and a first set of partition-level worker nodes as a statistical analysis group;
execute a statistical analysis phase on the partition-level worker node, wherein, in the statistical analysis phase, the instructions cause the processor to generate a group-level decision tree from statistical data derived from the data partition and the other statistical data received from the first set of partition-level worker nodes;
execute a decision tree analysis phase on the partition-level worker node, wherein, in the statistical analysis phase, the instructions cause the processor to generate a step decision tree based on a selection made from the group-level tree and other group-level trees received from other statistical analysis groups; and
cause a prediction model to be updated using the step decision tree.

13. The machine-readable storage device of claim 12, wherein the statistical data is a histogram of features in the data partition.

14. The machine-readable storage device of claim 12, wherein the statistical analysis assignment, the statistical analysis phase, and the decision tree analysis phase are part of a boosting step, and the instructions, when executed, further cause the processor to receive another statistical analysis assignment in a next boosting step, the another statistical analysis assignment groups the partition-level worker node with a second set of partition-level worker nodes in a different statistical analysis group.

15. The machine-readable storage device of claim 12, wherein the selection made from the group-level tree and the other group-level trees is based on respective error levels associated with the group-level decision tree and the other group-level decision trees.
